(19) United States
(12) Patent Application Publication
(10) Pub. No.: US 2014/0240737 A1
(43) Pub. Date: Aug. 28, 2014

(54) METHODS AND SYSTEMS FOR DESIGNING CELLS IN A PRODUCTION ENVIRONMENT

(71) Applicant: XEROX CORPORATION, Norwalk, CT (US)

(72) Inventors: Eric Michael Gross, Rochester, NY (US); Timothy Wayne Jacobs, Fairport, NY (US)

(73) Assignee: Xerox Corporation, Norwalk, CT (US)

(21) Appl. No.: 13/777,051

(22) Filed: Feb. 26, 2013

(51) Int. Cl. G06F 3/12

(52) U.S. Cl. CPC G06F 3/1226
USPC 358/1.13

(57) ABSTRACT

A method of designing a cell in a print production environment may include identifying one or more print jobs, grouping the one or more print jobs into one or more job groups, identifying a job group to assign to a cell, identifying a print job, determining a process, determining a job volume, and determining whether the cell includes a production device capable of performing the determined process. The method may include, in response to the cell not including a production device capable of performing the determined process, determining a production device capable of performing the determined process, determining a capacity, and in response to determining that adding the determined production device to the cell will not increase a number of production devices in the cell to a value that exceeds a threshold value, adding the determined production device to the cell, and determining a recalculated capacity.

### BACKGROUND

In production or service businesses, cellularization aggregates processes into organizational units designed to exploit similarities in how one makes products, serves customers or processes information. Designing optimal cells is often complex and computationally intractable, and there is a need for structured and automated or semi-automated approaches to speed the design cycle.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. Nothing in this document is to be construed as an admission that the embodiments described in this document are not entitled to antedate such disclosure by virtue of prior invention. As used herein, the term “comprising” means “including, but not limited to.”

In an embodiment, a method of designing a cell in a print production environment may include identifying one or more print jobs to process over a time period, grouping, by a computing device, the one or more print jobs into one or more job groups, identifying a job group from the one or more job groups to assign to a cell, identifying a print job from the identified job group, determining a process associated with performing the print job, determining a job volume associated with the determined process, and determining, by the computing device, whether the cell includes a production device capable of performing the determined process. The method may include, in response to the cell not including a production device capable of performing the determined process, determining a production device capable of performing the determined process, determining a capacity associated with the determined production device over the time period, determining whether adding the determined production device to the cell will increase a number of production devices in the cell to a value that exceeds a threshold value, and in response to determining that adding the determined production device to the cell will not increase a number of production devices in the cell to a value that exceeds a threshold value, adding the determined production device to the cell, and determining a recalculated capacity associated with the determined production device by subtracting the job volume from the capacity.

In an embodiment, a method of designing a cell in a print production environment may include identifying one or more print jobs to process over a time period, grouping the one or more print jobs into one or more job groups, identifying a job group from the one or more job groups to assign to a cell, identifying a print job from the identified job group, determining a process associated with performing the print job, determining a job volume associated with the determined process, determining whether the cell includes a production device capable of performing the determined process and in response to the cell including a production device capable of performing the determined process, determining a remaining capacity associated with the production device, determining whether the remaining capacity is sufficient to process the job volume, and in response to the remaining capacity not being sufficient to process the job volume, creating a second cell, and adding the production device to the second cell.

A system of designing a cell in a print production environment may include a computing device and a computer-readable storage medium in communication with the computing device. The computer-readable storage medium may include one or more programming instructions that, when executed, cause the computing device to identify one or more print jobs to process over a time period, group the one or more print jobs into one or more job groups, identify a job group from the one or more job groups to assign to a cell, identify a print job from the identified job group, determine a process associated with performing the print job, determine a job volume associated with the determined process, and determine whether the cell includes a production device capable of performing the determined process. The computer-readable storage medium may include one or more programming instructions that, when executed, cause the computing device to identify one or more print jobs to in response to the cell not including a production device capable of performing the determined process determine a production device capable of performing the determined process, determine a capacity associated with the determined production device over the time period, determine whether adding the determined production device to the cell will increase a number of production devices in the cell to a value that exceeds a threshold value, and in response to determining that adding the determined production device to the cell will not increase a number of production devices in the cell to a value that exceeds a threshold value, adding the determined production device to the cell, and determining a recalculated capacity associated with the determined production device by subtracting the job volume from the capacity.

### BRIEF DESCRIPTION OF THE DRAWINGS

FIG. 1 illustrates an example print production environment according to an embodiment.

FIGS. 2A & 2B illustrate an example method of designing one or more cells according to an embodiment.

FIG. 3 illustrates an example graphical user interface according to an embodiment.

FIG. 4 depicts a block diagram of hardware that may be used to contain or implement program instructions.

### DETAILED DESCRIPTION

The following terms shall have, for purposes of this application, the respective meanings set forth below:

A “cell” refers to one or more production devices in a production environment that are capable of processing at least a portion of a job. For example, in a print shop, a cell may include one or more print production devices that are capable of processing at least a portion of a print job.

A “computing device” refers to a device that includes a processor and tangible, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

A “job” refers to a logical unit of work that is to be completed for a customer. A job may include one or more print jobs from one or more clients. A production system may process a plurality of jobs.

A “print job” refers to a job processed in a print shop. For example, a print job may include producing credit card statements corresponding to a certain credit card company, producing bank statements corresponding to a certain bank, printing a document, or the like. Although the disclosed embodiments pertain to print jobs, the disclosed methods and systems can be applied to jobs in general in other production environments, such as automotive manufacturing, semiconductor production and the like.

A “process” refers to an operation performed by one or more production devices. Examples of functions pertaining to a print production device may include, without limitation, black-and-white printing, color printing, binding, punching, insertion and/or the like.

A “production device” device refers to a device used to process at least a portion of a job. Examples of production devices in a print shop may include, without limitation, printers, inserters, binders, punchers, collators, multi-function devices or other similar equipment and/or the like.

A production environment may include one or more autonomous production cells that each may include one or more production devices. In an embodiment, a cell may include one or more devices that are capable of delivering at least one type of job. For example, in a print shop, a cell may include production devices such as, for example, multiple printers, a shrink-wrapper and a computerized control system. A different cell may include printers, cutters and copiers. In an embodiment, print jobs may be intelligently routed to cells to provide desired load balancing and/or throughput. The use of cells may help decrease the amount of work in progress and labor and inventory costs associated with processing jobs, and may increase the utilization of the production devices in a production environment.

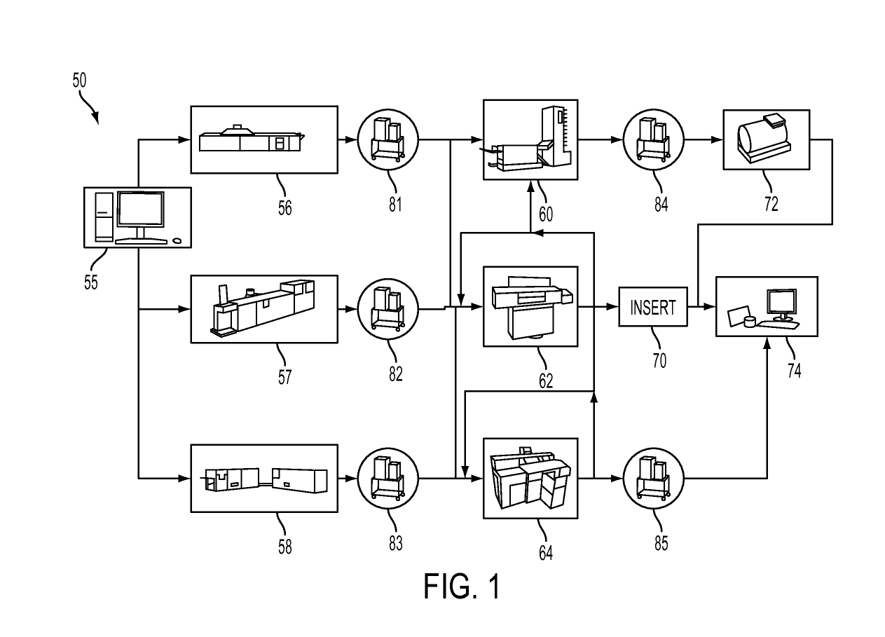

FIG. 1 shows an example of a production environment 50, in this case, example elements of a print shop. Print jobs may enter the print shop manually or electronically and be collected at an electronic submission system 55 such as a computing device and/or scanner. Jobs are sorted and batched at the submission system or another location before being delivered to one or more print engines such as a color printer 56, black-and-white printer 57 and/or a continuous feed printer 58. Jobs may exit the print engine and be delivered to one or more finishing devices or areas such as a collator 60, cutter 62, and/or binder 64. The finishing areas may include automatic or manual areas for such finishing activities and they also may include an automatic or manual inserter 70. Finally, jobs may move to a postage metering station 72 and/or shipping station 74. Jobs may move from one location to another in the print shop by automatic delivery or manual delivery such as by hand or by one or more paper carts 81-85.

In an embodiment, the design or composition of a cell may help increase the efficiency and throughput of the cell. For example, if a cell receives a large amount of black-and-white print jobs to process but only includes one black-and-white printer, then the cell may not efficiently process the print jobs its receives. Similarly, if a cell includes more production devices than demand requires, then the production environment may operate at a less than optimal utilization level.

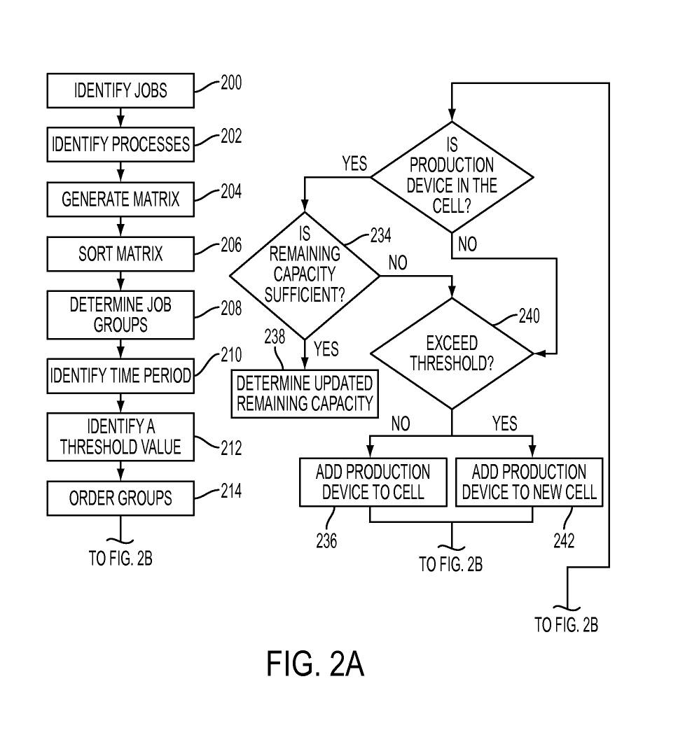

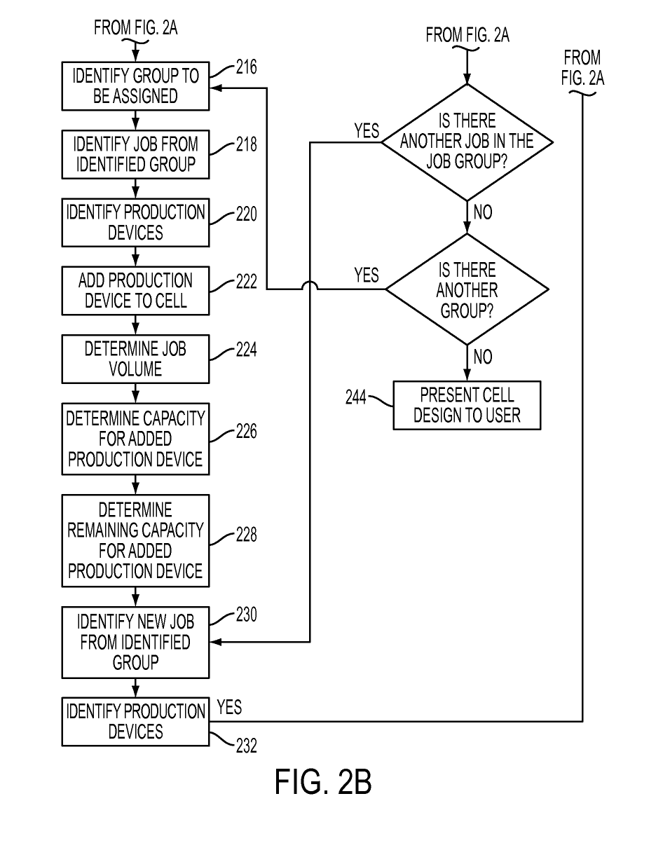

FIGS. 2A & 2B illustrate an example method of designing a cell in a production environment according to an embodiment. As illustrated by FIGS. 2A &2B, one or more jobs may be identified 200 and one or more processes associated with one or more of the identified jobs may be identified 202. In an embodiment, a job may involve one or more processes. A process may be a step involved in processing a job. For example, a print job may involve printing, binding and collating, each of which may be considered a process. In an embodiment, one or more historical jobs may be identified 200. A historical job may be a job previously processed by a production environment.

In an embodiment, one or more processes may be identified for one or more of the identified jobs. A matrix may be generated 204 that shows one or more processes that correspond to one or more jobs. Table 1 illustrates an example matrix according to an embodiment.

| Process/ | | | | | | | | | | |
|---|---|---|---|---|---|---|---|---|---|---|
| Job | | | | | | | | | Binary | Row sum |
| Type | Job 1 | Job 2 | Job 3 | Job 4 | Job 5 | Job 6 | Job 7 | Job 8 | values | values |
| A | 1 | | 1 | | 1 | | | | 32 | 168 |
| B | | | | 1 | | | | 1 | 16 | 17 |
| C | 1 | | 1 | | 1 | | | | 8 | 168 |
| D | | | | 1 | | | | 1 | 4 | 17 |
| E | | 1 | | | 1 | 1 | 1 | | 2 | 78 |
| F | | 1 | | | | 1 | 1 | 1 | 1 | 71 |
| Binary | 128 | 64 | 32 | 16 | 8 | 4 | 2 | 1 | | |
| values | | | | | | | | | | |
| Column | 40 | 3 | 40 | 20 | 42 | 3 | 3 | 21 | | |
| sum | | | | | | | | | | |
| values | | | | | | | | | | |

In an embodiment, a cell that includes a ‘1’ may indicate that a particular job includes a process. A cell that includes a ‘0’ or a cell that is empty may indicate that a particular job does not include a process. For example, referring to Table 1, Job 1 includes Process A and Process C.

In an embodiment, one or more jobs and one or more processes may be associated with a binary value. The binary values may be arranged in an order of magnitude. For example, as illustrated by Table 1, Process A may be associated with a binary value of ‘32’ and Process B may be associated with a binary value of ‘16.’ Similarly, as illustrated by Table 1, Job 1 may be associated with a binary value of ‘128’ and Job 2 may be associated with a binary value of ‘68.’

A matrix may include a row sum value and a column sum value for one or more of the cells in the matrix. A row sum value may be the sum of the binary values associated with each process having a ‘1’ value in the matrix. For example, as illustrated by Table 1, the row sum value for the Process A row may be ‘168’, which is the sum of the binary values associated with Job 1, Job 3 and Job 5 (e.g., 128+32+8), each of which have a value of ‘1’ in the matrix.

Similarly, a column sum value may be the sum of the binary values associated with each job having a ‘1’ value in the matrix. For example, as illustrated by Table 1, the column sum value for the Job 1 column may be ‘40’, which is the sum of the binary values associated with Process A and Process C (e.g., 32+8), each of which have a value of ‘1’ in the matrix.

In an embodiment, a matrix may be sorted 206. The rows of the matrix may be sorted 206 by their associated row sum values. The rows may be sorted 206 from highest to lowest row sum value or from lowest to highest row sum value. In an embodiment, the columns of matrix may then be sorted 206 by their associated column sum values. The columns may be sorted 206 from highest to lowest column sum value or from lowest to highest column sum value.

In an embodiment, the rows and columns of a matrix may be sorted 206 until swapping rows and/or columns no longer results in a change in row sum or column sum values. The result may be a block diagonal partitioning of the matrix that illustrates process-type job groupings. Table 2 illustrates an example result of sorting the matrix illustrated in Table 1 according to an embodiment. As illustrated by Table 2, reordering the matrix may change one or more row sum values and/or column sum values associated with the matrix.

TABLE 2

| Process/ | | | | | | | | | | |
|---|---|---|---|---|---|---|---|---|---|---|
| Job | | | | | | | | | Binary | Row sum |
| Type | Job 1 | Job 3 | Job 5 | Job 7 | Job 2 | Job 6 | Job 8 | Job 4 | values | values |
| A | 1 | 1 | 1 | | | | | | 32 | 224 |
| C | 1 | 1 | 1 | | | | | | 16 | 224 |
| E | | | 1 | 1 | 1 | 1 | | | 8 | 60 |
| F | | | | 1 | 1 | 1 | 1 | | 4 | 30 |
| D | | | | | | | 1 | 1 | 2 | 3 |
| B | | | | | | | 1 | 1 | 1 | 3 |
| Binary | 128 | 64 | 32 | 16 | 8 | 4 | 2 | 1 | | |
| values | | | | | | | | | | |
| Column | 48 | 48 | 56 | 12 | 12 | 12 | 7 | 3 | | |
| sum | | | | | | | | | | |
| values | | | | | | | | | | |

In an embodiment, one or more job groups may be determined 208. One or more job groups may be determined 208 based on a reordered job-process matrix according to an embodiment. A job group may include one or more jobs having a common set of attributes. For example, the set of processes that a job requires may be used to define a job group. As such, if two different jobs require performing the same processes to complete the jobs, then they may be classified as belonging to the same job group.

In an embodiment, the attribute of job size may be considered in determining job groups. For example, two jobs may require performing the same processes to complete the jobs, but the jobs may differ in size. For instance, one job may be considered “large” whereas the other job may be considered “small.” As such, the time to process each job may differ as well. Accordingly, each job may be classified in a different job group.

In an embodiment, certain restrictions may apply to determining job groups. For example, a certain job type may be identified as not being allowed to be processed by a certain cell. As another example, a certain job type may be identified as not being able to co-exist with one or more other jobs types in the same cell. Additional and/or alternate restrictions may be used within the scope of this disclosure.

In an embodiment, a reordered matrix may illustrate one or more process-type job groups. For example, referring to Table 2, Job 1, Job 3 and Job 5 may be considered a job group because each of these jobs requires Process A and Process C. Similarly, Job 7, Job 2 and Job 6 may be considered a job group.

In an embodiment, a time period may be identified 210. A time period may be one over which jobs for which a cell is being designed flow into the system. For example, a cell may be designed to process jobs flowing into a production environment in the next month. Additional and/or alternate time periods may be used within the scope of this disclosure.

In an embodiment, the time period should capture a reasonable representation of job volume variability and/or maximum expected volumes. In an embodiment, a time period may be identified 210 by a user. In another embodiment, a time period may be automatically identified 210 by the system.

In an embodiment, a threshold value may be identified 212. A threshold value may represent a maximum number of production devices per cell. Available space and cell team size may be considered in identifying 212 a maximum number of production devices per cell. In an embodiment, a user may identify 212 a maximum number of production devices per cell. In another embodiment, a maximum number of production devices per cell may be identified 212 by the system.

In an embodiment, the identified job groups may be ordered 214. The identified job groups may be ordered 214 based on an associated importance metric. An importance metric may measure a degree of importance of each grouping based on one or more job attributes. For example, job volume, profitability, cost of penalty if late and/or other business considerations may be examples of job attributes from which an importance metric may be determined. In an embodiment, an importance metric may be an alphanumeric character or sequence of characters. For example, an importance metric may be a number between 1 and 10 where 10 represents the highest level of importance and 1 represents the lowest level of importance.

In an embodiment, a user may determine an importance metric. For example, a user may identify the relative importance of one or more job groupings by assigning or selecting an importance metric for one or more groups. In another embodiment, an importance metric may be automatically determined for one or more job groups. An importance metric may be automatically determined based on one or more job attributes. For example, an importance metric may be job size, and an importance metric may be assigned to job groups accordingly. Additional and/or alternate job attributes may be used within the scope of this disclosure.

Table 3 illustrates example importance metrics associated with the job groups illustrated in Table 2 according to an embodiment. As illustrated by Table 3, Job Group 2 has the highest importance metric, followed by Job Group 3 and Job Group 1. As such, the job groups may be ordered {Job Group 2, Job Group 3, Job Group 1}.

TABLE 3

| Job | | Importance |
|---|---|---|
| Group | Jobs | Metric |
| 1 | Jobs 1, 3, 5 | 3 |
| 2 | Jobs 7, 2, 6 | 7 |
| 3 | Jobs 8, 4 | 4 |

In an embodiment, ordering 214 job groups based on an importance metric may be an optional step. But doing so may ensure that capacity within a cell is assigned to the most important jobs first.

In an embodiment, a job group to be assigned to a cell may be identified 216. In an embodiment, the identified job group may be a job group having a highest importance metric. Alternatively, a job group may be identified 216 randomly.

In an embodiment, a job from the identified job group may be identified 218, and one or more production devices that are needed to process the identified job may be determined 220. In an embodiment, there may be more than one option with respect to production devices. For example, a black-and-white printer may be used to perform black-and-white printing. But, in an embodiment, a multifunction device that is capable of performing other processes may also perform black-and-white printers. As another example, different types, models and/or the like of black-and-white printers may be available.

In an embodiment, a production device may be selected based on one or more performance metrics associated with the device. For example, reliability, operational costs, and throughput may be considered in determining which production device to use. Additional and/or alternate performance metrics may be considered.

In an embodiment, the identified production devices may be added 222 to a cell. For example, an indication of the identified production device may be added 222 to an electronic representation of a cell. The result may be a cell design file that includes an indication of the identified production device.

In an embodiment, if no other job groups have been considered, the cell may initially be empty. For example, referring to Table 3, based on the importance metrics, Job Group 2 may be identified 216, and Job 7 may be identified 218. As illustrated by Tables 1 and 2, Job 7 requires Processes E and F. As such, one or more production devices that are needed to perform Process E and Process F may be added to a cell. In an embodiment, if Process E and Process F can be performed by a single device, such as, for example, a multifunction device, only one device may be assigned to a cell.

In an embodiment, a job volume associated with one or more processes of the identified job may be determined 224. A job volume may represent the amount of the identified job that requires a process over the time period that was identified 210. For example, referring back to the example, Job 7 requires Process E and Process F. In an embodiment, Process E may be black-and-white printing and Process F may be color printing. Job 7 may require 3,200 black-and-white pages over the identified time period and 3,000 color pages over the identified time period.

In an embodiment, a capacity may be determined 226 for an added production device for one or more processes. A capacity may indicate an amount of a process that a production device can handle over a time period. For example, a capacity may indicate an amount of a process that the production device can handle over the identified time period. In an embodiment, a capacity may be dependent on the process the device is performing.

Referring back to the previous example, a multi-function device capable of black-and-white printing and color printing may be added to a cell to process Job 7. The added device may have a capacity of 7,000 pages of black-and-white printing over the identified time period, and a capacity of 6,000 pages of color printing over the identified time period.

In an embodiment, a remaining capacity of the cell may be determined 228 for one or more processes. In an embodiment, a remaining capacity may represent the capacity of a cell after processing one or more assigned jobs. A remaining capacity for a process may be determined by subtracting the job volume for a process of an assigned job from the production device's capacity for that process. For example, referring to the example above, a remaining capacity for black-and-white printing may be 3,800 pages (i.e., 7,000 pages-3,200 pages). Similarly, a remaining capacity for color printing may be 3,000 pages (i.e., 6,000 pages-3,000 page).

In an embodiment, a new job from the identified job group may be identified 230. If there are no constraints or restrictions associated with processing the new job by the current cell, then one or more production devices that are needed to process the new job may be determined 232.

If one or more of the determined production devices are already present in the cell, then it may be determined 234 whether the remaining capacity associated with the production device for one or more processes is sufficient to process the new job. For instance, referring to the above example, Job 2 may be selected from Job Group 2. Job 2 requires Process E and Process F. The cell currently includes a multi-function device capable of performing Process E and Process F. As such, it may be determined 234 whether the remaining capacity of the multi-function device to perform Process E and Process F is sufficient to process Job 2.

In an embodiment, Job 2 may require 3,500 black-and-white pages and 2,800 color pages. As such, the remaining capacity for both processes is sufficient to process Job 2 by the same production device. In an embodiment, the remaining capacity for the processes may be decremented by the appropriate amounts.

In an embodiment, if it is determined that the remaining capacity is sufficient to process the new job, then an updated remaining capacity may be determined 238 for the production device by subtracting the job volume from the current remaining capacity for the production device.

In an embodiment, if it is determined that the remaining capacity is insufficient to process the new job, then it may be determined 240 whether adding the production device to the cell would increase the total number of production devices in the cell beyond the threshold value. If adding the production device would increase the total number of production devices in the cell beyond the threshold value, then an indication of the production device may be added 242 to an electronic representation of the new cell, such as a cell design file. In an embodiment, if adding the production device would not increase the total number of production devices in the cell beyond the threshold value, the production device may be added 236 to the current cell.

In an embodiment, if the determined production devices are not already present in the cell, then it may be determined 240 whether adding the production device to the cell would increase the total number of production devices in the cell beyond the threshold value. If adding the production device would increase the total number of production devices in the cell beyond the threshold value, then an indication of the production device may be added 242 to an electronic representation of the new cell, such as a cell design file. In an embodiment, if adding the production device would not increase the total number of production devices in the cell beyond the threshold value, the production device may be added 236 to the current cell.

For example, referring to the above example, Job 6 in Job Group 2 may be identified as the last job in the group to be assigned. Job 6 may require 1,000 pages of black-and-white printing and 700 pages of color printing. However, both of these job volumes exceed the current remaining capacity of the cell. As such, one or more other production devices may be added 236 to the cell to accommodate the job volumes of Job 6 so long as adding the production devices does not increase the total number of devices in the cell beyond a threshold value.

In an embodiment, as illustrated by FIGS. 2A & 2B, groups and jobs may be identified, production devices may be added and capacity may be determined and/or recomputed until each job has been considered. The cell composition that results may represent a suggested cell design according to an embodiment.

The suggested cell design may be presented 244 to a user. For example, a graphical user interface (GUI) that includes a representation of one or more cells, one or more production devices and/or one or more jobs may be displayed to a user.

In an embodiment, the above-described cell design methodology may be automatically performed by a computing device. Alternatively, the method may include one or more user inputs. For example, a user may add or change the composition of a cell by dragging and dropping, or otherwise selecting, an icon or other representation of a production device into a representation of a cell. Doing so may automatically recalculate capacities associated with the cell which may also be presented to the user. Similarly, a user may remove a production device from a cell by selecting an icon or other representation of a production and moving the representation from the cell. Again, doing so may automatically recalculate capacities associated with the cell which may also be presented to the user. As such, designing one or more cells in a production environment may be an interactive task.

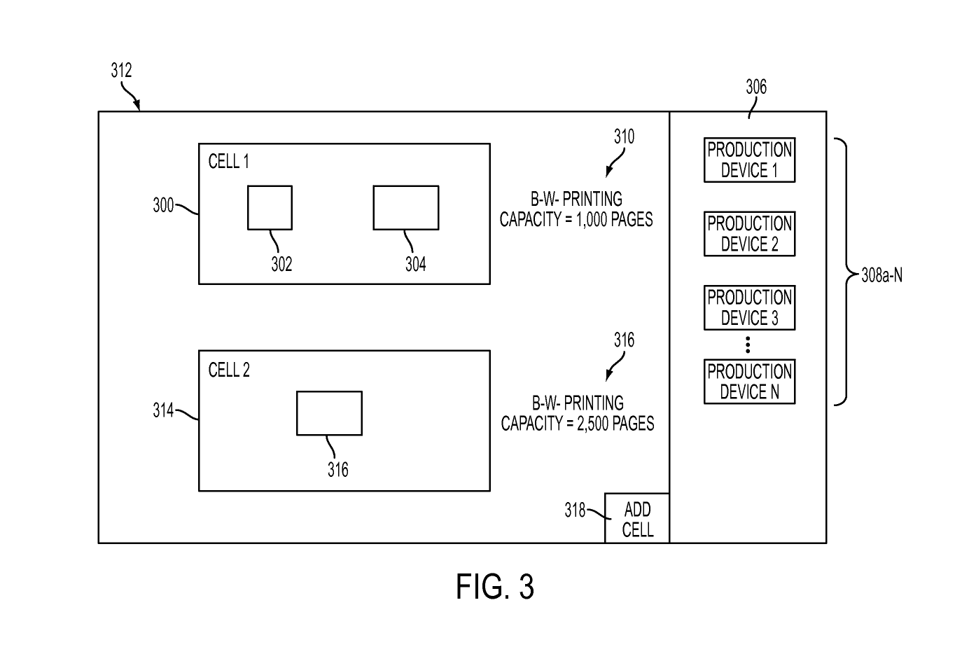

FIG. 3 illustrates an example GUI that a user may use to design one or more cells. As illustrated by FIG. 3, the GUI 312 may include an area 306 that includes representations 308a-N of one or more production devices. The GUI may include an area that shows a current composition of one or more cells. For example, as illustrated by FIG. 3, area 300 illustrates representations 302, 304 of two production devices that are currently a part of Cell 1, while area 314 illustrates a representation 316 of one production device that is currently a part of Cell 2. In an embodiment, the GUI may display an indication of a remaining capacity associated with one or more processes for one or more cells. For example, as illustrated by FIG. 3, the GUI 312 displays an indication 310 that the remaining capacity for black-and-white printing for is 1,000 pages for Cell 1 and 2,500 pages for Cell 2.

In an embodiment, a GUI may display a graphical representation associated with adding a new cell. For example, FIG. 3 illustrates an example button 318 associated with adding a new cell to the layout. A user may add one or more cells to the layout by selecting the button according to an embodiment.

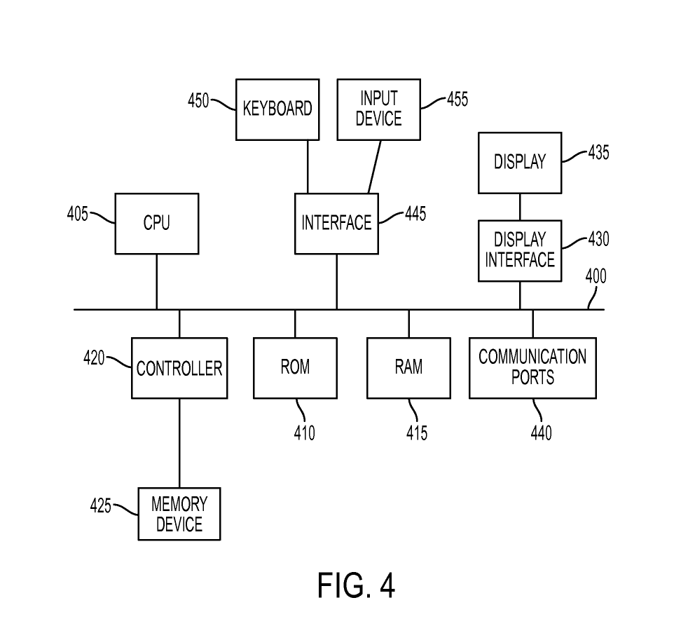

FIG. 4 depicts a block diagram of hardware that may be used to contain or implement program instructions to perform the methods described above. A bus 400 serves as an information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an example of a production device, computing device or processor as such terms are used within this disclosure. Read only memory (ROM) 410 and random access memory (RAM) 415 constitute examples of non-transitory computer-readable storage media.

A controller 420 interfaces with one or more optional non-transitory computer-readable storage media 425 to the system bus 400. These storage media 425 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 410 and/or the RAM 415. Optionally, the program instructions may be stored on a tangible non-transitory computer-readable medium such as a compact disk, a digital disk, flash memory, a memory card, a USB drive, an optical disc storage medium, such as a Blu-ray™ disc, and/or other recording medium.

An optional display interface 430 may permit information from the bus 400 to be displayed on the display 435 in audio, visual, graphic or alphanumeric format. Communication with external devices, such as a printing device, may occur using various communication ports 440. A communication port 440 may be attached to a communications network, such as the Internet or an intranet.

The hardware may also include an interface 445 which allows for receipt of data from input devices such as a keyboard 450 or other input device 455 such as a mouse, a joystick, a touch screen, a remote control, a pointing device, a video input device and/or an audio input device.

Various of the above-disclosed and other features and functions, or alternatives thereof, may be desirably combined into many other different systems or applications or combinations of systems and applications. Various presently unforeseen or unanticipated alternatives, modifications, variations or improvements therein may be subsequently made by those skilled in the art which are also intended to be encompassed by the following claims.

What is claimed is:

1. A method of designing a cell in a print production environment, the method comprising:
identifying one or more print jobs to process over a time period;
grouping, by a computing device, the one or more print jobs into one or more job groups;
identifying a job group from the one or more job groups to assign to a cell;
identifying a print job from the identified job group;
determining a process associated with performing the print job;
determining a job volume associated with the determined process;
determining, by the computing device, whether the cell includes a production device capable of performing the determined process; and
in response to the cell not including a production device capable of performing the determined process:
determining a production device capable of performing the determined process,
determining a capacity associated with the determined production device over the time period,
determining whether adding the determined production device to the cell will increase a number of production devices in the cell to a value that exceeds a threshold value, and
in response to determining that adding the determined production device to the cell will not increase a number of production devices in the cell to a value that exceeds a threshold value:
adding the determined production device to the cell, and
determining a recalculated capacity associated with the determined production device by subtracting the job volume from the capacity.

2. The method of claim 1, wherein grouping the one or more print jobs into one or more job groups comprises:
generating a matrix comprising a plurality of rows and a plurality of columns, wherein each row is associated with a process and each column is associated with one of the print jobs;
wherein each row is associated with a row sum value representing a sum of binary numbers associated with the print jobs requiring the process represented by the row;
wherein each column is associated with a column sum value representing a sum of binary numbers associated with the processes associated with the print job represented by the column; and
sorting the rows by their row sum values and sorting the columns by their column sum values.

3. The method of claim 1, wherein identifying a job group from the one or more job groups to assign to a cell comprises:
identifying an importance metric for each group, wherein the importance metric is based on one or more of the following:
job volume,
profitability, and
a penalty cost; and
identifying the job group having the highest importance metric.

4. The method of claim 1, wherein determining a production device capable of performing the determined process comprises:
identifying a plurality of production devices capable of performing the determined process; and
selecting a production device from the plurality of production devices based on one or more of the following performance metrics:
reliability,
operational cost, and
throughput.

5. The method of claim 1, further comprising:
identifying a second print job from the identified job group;
determining a second process associated with performing the second print job;
determining a second job volume associated with the second process;
determining whether the cell includes a production device capable of performing the second process; and
in response to the cell not including a production device capable of performing the second process:
determining a production device capable of performing the second process,
determining a capacity associated with the determined production device over the time period,
determining whether adding the determined production device to the cell will increase a number of production devices in the cell to a value that exceeds a threshold value, and
in response to determining that adding the determined production device to the cell will not increase a number of production devices in the cell to a value that exceeds a threshold value:
adding the determined production device to the cell, and
determining a recalculated capacity associated with the determined production device by subtracting the second job volume from the capacity.

6. The method of claim 1, further comprising:
identifying a second print job from the identified job group;
determining a second process associated with performing the second print job;
determining a second job volume associated with the second process;
determining whether the cell includes a production device capable of performing the second process; and
in response to determining that the cell including a production device capable of performing the second process:
determining a remaining capacity associated with the production device that is capable of performing the second process,
determining whether the remaining capacity is sufficient to process the second job volume, and
in response to determining that the remaining capacity is sufficient to process the second volume, determining an updated remaining capacity for the production device by subtracting the second job volume from the remaining capacity.

7. The method of claim 1, further comprising:
identifying a second print job from the identified job group;
determining a second process associated with performing the second print job;
determining a second job volume associated with the second process;
determining whether the cell includes a production device capable of performing the second process; and
in response to determining that the cell includes a production device capable of performing the second process:
determining a remaining capacity associated with the production device that is capable of performing the second process,
determining whether the remaining capacity is sufficient to process the second job volume, and
in response to determining that the remaining capacity is not sufficient to process the second volume:
determining whether adding the determined production device to the cell will increase a number of production devices in the cell to a value that exceeds a threshold value,
in response to determining that adding the determined production device to the cell will not increase a number of production devices in the cell to a value that exceeds a threshold value:
adding the determined production device to the cell, and
determining an updated remaining capacity for the production device by subtracting the second job volume from the remaining capacity.

8. The method of claim 1, further comprising:
identifying a second print job from the identified job group;
determining a second process associated with performing the second print job;
determining a second job volume associated with the second process;
determining whether the cell includes a production device capable of performing the second process; and
in response to determining that the cell includes a production device capable of performing the second process:
determining a remaining capacity associated with the production device that is capable of performing the second process,
determining whether the remaining capacity is sufficient to process the second job volume, and
in response to determining that the remaining capacity is not sufficient to process the second volume:
determining whether adding the determined production device to the cell will increase a number of production devices in the cell to a value that exceeds a threshold value, and
in response to determining that adding the determined production device to the cell will increase a number of production devices in the cell to a value that exceeds a threshold value:
adding the determined production device to a second cell, and
determining an updated remaining capacity for the production device by subtracting the second job volume from the remaining capacity.

9. A method of designing a cell in a print production environment, the method comprising:
identifying one or more print jobs to process over a time period;
grouping the one or more print jobs into one or more job groups;
identifying a job group from the one or more job groups to assign to a cell;
identifying a print job from the identified job group;
determining a process associated with performing the print job;
determining a job volume associated with the determined process;
determining whether the cell includes a production device capable of performing the determined process; and
in response to the cell including a production device capable of performing the determined process:
determining a remaining capacity associated with the production device,
determining whether the remaining capacity is sufficient to process the job volume, and
in response to the remaining capacity not being sufficient to process the job volume:
creating a second cell, and
adding the production device to the second cell.

10. The method of claim 9, wherein grouping the one or more print jobs into one or more job groups comprises:
generating a matrix comprising a plurality of rows and a plurality of columns, wherein each row is associated with a process and each column is associated with one of the print jobs;
wherein each row is associated with a row sum value representing a sum of binary numbers associated with the print jobs requiring the process represented by the row;
wherein each column is associated with a column sum value representing a sum of binary numbers associated with the processes associated with the print job represented by the column; and
sorting the rows by their row sum values and sorting the columns by their column sum values

11. The method of claim 9, wherein identifying a job group from the one or more job groups to assign to a cell comprises:
identifying an importance metric for each group, wherein the importance metric is based on one or more of the following:
job volume,
profitability, and
a penalty cost; and
identifying the job group having the highest importance metric.

12. The method of claim 9, wherein determining a production device capable of performing the determined process comprises:
identifying a plurality of production devices capable of performing the determined process; and
selecting a production device from the plurality of production devices based on one or more of the following performance metrics:
reliability,
operational cost, and
throughput.

13. The method of claim 9, further comprising:
identifying a second print job from the identified job group;
determining a second process associated with performing the second print job;
determining a second job volume associated with the second process;
determining whether the cell includes a production device capable of performing the second process; and
in response to the cell not including a production device capable of performing the second process:
determining a production device capable of performing the second process,
determining a capacity associated with the determined production device over the time period,
determining whether adding the determined production device to the cell will increase a number of production devices in the cell to a value that exceeds a threshold value, and
in response to determining that adding the determined production device to the cell will not increase a number of production devices in the cell to a value that exceeds a threshold value:
adding the determined production device to the cell, and
determining a recalculated capacity associated with the determined production device by subtracting the second job volume from the capacity.

14. The method of claim 9, further comprising:
identifying a second print job from the identified job group;
determining a second process associated with performing the second print job;
determining a second job volume associated with the second process;
determining whether the cell includes a production device capable of performing the second process; and
in response to determining that the cell including a production device capable of performing the second process:
determining a remaining capacity associated with the production device that is capable of performing the second process,
determining whether the remaining capacity is sufficient to process the second job volume, and
in response to determining that the remaining capacity is sufficient to process the second volume, determining an updated remaining capacity for the production device by subtracting the second job volume from the remaining capacity.

15. The method of claim 9, further comprising:
identifying a second print job from the identified job group;
determining a second process associated with performing the second print job;
determining a second job volume associated with the second process;
determining whether the cell includes a production device capable of performing the second process;
in response to determining that the cell includes a production device capable of performing the second process:
determining a remaining capacity associated with the production device that is capable of performing the second process,
determining whether the remaining capacity is sufficient to process the second job volume, and
in response to determining that the remaining capacity is not sufficient to process the second volume:
determining whether adding the determined production device to the cell will increase a number of production devices in the cell to a value that exceeds a threshold value, and
in response to determining that adding the determined production device to the cell will not increase a number of production devices in the cell to a value that exceeds a threshold value:
adding the determined production device to the cell, and
determining an updated remaining capacity for the production device by subtracting the second job volume from the remaining capacity.

16. The method of claim 9, further comprising:
identifying a second print job from the identified job group;
determining a second process associated with performing the second print job;
determining a second job volume associated with the second process;
determining whether the cell includes a production device capable of performing the second process; and
in response to determining that the cell includes a production device capable of performing the second process:
determining a remaining capacity associated with the production device that is capable of performing the second process,
determining whether the remaining capacity is sufficient to process the second job volume, and
in response to determining that the remaining capacity is not sufficient to process the second volume:
determining whether adding the determined production device to the cell will increase a number of production devices in the cell to a value that exceeds a threshold value, and
in response to determining that adding the determined production device to the cell will increase a number of production devices in the cell to a value that exceeds a threshold value:
adding the determined production device to the second cell in response to:
determining that the second cell does not include a production device capable of performing the second process, and
determining that adding the determined production device to the second cell will not increase a number of production devices in the second cell to a value that exceeds the threshold value.

17. A system of designing a cell in a print production environment, the system comprising:
a computing device; and
a computer-readable storage medium in communication with the computing device, wherein the computer-readable storage medium comprises one or more programming instructions that, when executed, cause the computing device to:
identify one or more print jobs to process over a time period,
group the one or more print jobs into one or more job groups,
identify a job group from the one or more job groups to assign to a cell,
identify a print job from the identified job group,
determine a process associated with performing the print job,
determine a job volume associated with the determined process,
determine whether the cell includes a production device capable of performing the determined process, and
in response to the cell not including a production device capable of performing the determined process:
determine a production device capable of performing the determined process,
determine a capacity associated with the determined production device over the time period,
determine whether adding the determined production device to the cell will increase a number of production devices in the cell to a value that exceeds a threshold value, and
in response to determining that adding the determined production device to the cell will not increase a number of production devices in the cell to a value that exceeds a threshold value:
adding the determined production device to the cell, and
determining a recalculated capacity associated with the determined production device by subtracting the job volume from the capacity.

18. The system of claim 17, wherein the one or more programming instructions that, when executed, cause the computing device to identify a job group from the one or more job groups to assign to a cell comprises one or more programming instructions that, when executed, cause the computing device to:
identify an importance metric for each group, wherein the importance metric is based on one or more of the following:
job volume,
profitability, and
a penalty cost, and
identify the job group having the highest importance metric.

19. The system of claim 17, wherein the computer-readable storage medium further comprises one or more programming instructions that, when executed, cause the computing device to:
identify a second print job from the identified job group;
determine a second process associated with performing the second print job;
determine a second job volume associated with the second process;
determine whether the cell includes a production device capable of performing the second process; and
in response to the cell not including a production device capable of performing the second process:
determine a production device capable of performing the second process,
determine a capacity associated with the determined production device over the time period,
determine whether adding the determined production device to the cell will increase a number of production devices in the cell to a value that exceeds a threshold value, and
in response to determining that adding the determined production device to the cell will not increase a number of production devices in the cell to a value that exceeds a threshold value:
add the determined production device to the cell, and
determine a recalculated capacity associated with the determined production device by subtracting the second job volume from the capacity.

20. The system of claim 17, wherein the computer-readable storage medium further comprises one or more programming instructions that, when executed, cause the computing device to:
identify a second print job from the identified job group;
determine a second process associated with performing the second print job;
determine a second job volume associated with the second process;
determine whether the cell includes a production device capable of performing the second process; and
in response to determining that the cell including a production device capable of performing the second process:
determine a remaining capacity associated with the production device that is capable of performing the second process,
determine whether the remaining capacity is sufficient to process the second job volume, and
in response to determining that the remaining capacity is sufficient to process the second volume, determine an updated remaining capacity for the production device by subtracting the second job volume from the remaining capacity.

21. The system of claim 17, wherein the computer-readable storage medium further comprises one or more programming instructions that, when executed, cause the computing device to:
identify a second print job from the identified job group;
determine a second process associated with performing the second print job;
determine a second job volume associated with the second process;
determine whether the cell includes a production device capable of performing the second process; and
in response to determining that the cell includes a production device capable of performing the second process:
determine a remaining capacity associated with the production device that is capable of performing the second process,
determine whether the remaining capacity is sufficient to process the second job volume, and
in response to determining that the remaining capacity is not sufficient to process the second volume:
determine whether adding the determined production device to the cell will increase a number of production devices in the cell to a value that exceeds a threshold value, and
in response to determining that adding the determined production device to the cell will not increase a number of production devices in the cell to a value that exceeds a threshold value:
add the determined production device to the cell, and
determine an updated remaining capacity for the production device by subtracting the second job volume from the remaining capacity.

22. The system of claim 17, wherein the computer-readable storage medium further comprises one or more programming instructions that, when executed, cause the computing device to:
identify a second print job from the identified job group;
determine a second process associated with performing the second print job;
determine a second job volume associated with the second process;
determine whether the cell includes a production device capable of performing the second process; and
in response to determining that the cell includes a production device capable of performing the second process:
determine a remaining capacity associated with the production device that is capable of performing the second process,
determine whether the remaining capacity is sufficient to process the second job volume, and
in response to determining that the remaining capacity is not sufficient to process the second volume:
determine whether adding the determined production device to the cell will increase a number of production devices in the cell to a value that exceeds a threshold value, and
in response to determining that adding the determined production device to the cell will increase a number of production devices in the cell to a value that exceeds a threshold value:
add the determined production device to a second cell, and
determine an updated remaining capacity for the production device by subtracting the second job volume from the remaining capacity.
